(19) United States
(12) Patent Application Publication
(10) Pub. No.: US 2012/0216219 A1
(43) Pub. Date: Aug. 23, 2012

(54) METHODS AND APPARATUS FOR DYNAMIC CUSTOMIZATION OF CLINICAL WORKFLOWS

(75) Inventors: Niranjan Kumar Sharma, Salt Lake City, UT (US); Alan F. James, Salt Lake City, UT (US)

(73) Assignee: GENERAL ELECTRIC COMPANY, A NEW YORK CORPORATION, Schenectady, NY (US)

(21) Appl. No.: 13/031,372

(22) Filed: Feb. 21, 2011

(51) Int. Cl. G06F 9/44

(52) U.S. Cl. 719/331

(57) ABSTRACT

Methods and apparatus for dynamic customization of clinical workflows are disclosed. An example method includes receiving a script that implements one or more actions of a clinical workflow from a first healthcare entity that utilizes an electronic clinical information system, wherein the electronic clinical information system aggregates healthcare information from a plurality of healthcare entities including the first healthcare entity; loading the script into a dynamic module core framework that interacts with a runtime environment to execute application bundles; and publishing the script of the dynamic module core framework to the runtime environment such that the clinical workflow is installed into the electronic clinical information system dynamically at runtime.

### FIELD OF THE DISCLOSURE

The present disclosure relates generally to healthcare information systems and, more particularly, to methods and apparatus for dynamic customization of clinical workflows.

### BACKGROUND

Healthcare environments, such as hospitals and clinics, typically include information systems (e.g., electronic medical record (EMR) systems, lab information systems, outpatient and inpatient systems, hospital information systems (HIS), radiology information systems (RIS), storage systems, picture archiving and communication systems (PACS), etc.) to manage clinical information such as, for example, patient medical histories, imaging data, test results, diagnosis information, management information, financial information, and/or scheduling information. These healthcare information systems are used to implement different types of workflows in which clinical information is generated, updated, augmented, and/or otherwise processed for one or more purposes.

### SUMMARY

An example computer implemented method includes receiving a script that implements one or more actions of a clinical workflow from a first healthcare entity that utilizes an electronic clinical information system, wherein the electronic clinical information system aggregates healthcare information from a plurality of healthcare entities including the first healthcare entity; loading the script into a dynamic module core framework that interacts with a runtime environment to execute application bundles; and publishing the script of the dynamic module core framework to the runtime environment such that the clinical workflow is installed into the electronic clinical information system dynamically at runtime.

An example tangible machine readable medium has instructions stored thereon that, when executed, cause a machine to at least receive a script that implements one or more actions of a clinical workflow from a first healthcare entity that utilizes an electronic clinical information system, wherein the electronic clinical information system aggregates healthcare information from a plurality of healthcare entities including the first healthcare entity; load the script into a dynamic module core framework that interacts with a runtime environment to execute application bundles; and publish the script of the dynamic module core framework to the runtime environment such that the clinical workflow is installed into the electronic clinical information system dynamically at runtime.

An example apparatus includes an application container to receive a script that implements one or more actions of a clinical workflow from a first healthcare entity that utilizes an electronic clinical information system, wherein the electronic clinical information system aggregates healthcare information from a plurality of healthcare entities including the first healthcare entity; a dynamic module core framework into which the script is to be loaded that interacts with a runtime environment to execute application bundles; and a dependency injection framework to publish the script of the dynamic module core framework to the runtime environment such that the clinical workflow is installed into the electronic clinical information system dynamically at runtime.

### BRIEF DESCRIPTION OF THE DRAWINGS

FIG. 1 is a block diagram of an example healthcare information environment.

FIG. 2 is a block diagram of an example apparatus that may be used to implement the example dynamic clinical workflow system of FIG. 1.

FIG. 3 is a layer model of the example core framework of FIG. 2.

FIG. 4 is a diagram illustrating interactions of the application bundles of FIG. 2 with the service registry of FIG. 2.

FIG. 5 is a flow diagram representative of example machine readable instructions that may be executed to implement the example dynamic clinical workflow system of FIGS. 1 and/or 2.

FIG. 6 is a block diagram of an example processor system that may be used to execute the machine readable instructions of FIG. 5 to implement the example dynamic clinical workflow system of FIGS. 1 and/or 2.

The foregoing summary, as well as the following detailed description of certain implementations of the methods, apparatus, systems, and/or articles of manufacture described herein, will be better understood when read in conjunction with the appended drawings. It should be understood, however, that the methods, apparatus, systems, and/or articles of manufacture described herein are not limited to the arrangements and instrumentality shown in the attached drawings.

### DETAILED DESCRIPTION

Although the following discloses example methods, apparatus, systems, and articles of manufacture including, among other components, firmware and/or software executed on hardware, it should be noted that such methods, apparatus, systems, and/or articles of manufacture are merely illustrative and should not be considered as limiting. For example, it is contemplated that any or all of these firmware, hardware, and/or software components could be embodied exclusively in hardware, exclusively in software, exclusively in firmware, or in any combination of hardware, software, and/or firmware. Accordingly, while the following describes example methods, apparatus, systems, and/or articles of manufacture, the examples provided are not the only way(s) to implement such methods, apparatus, systems, and/or articles of manufacture.

Entities of healthcare enterprises operate according to a plurality of clinical workflows. Clinical workflows are typically defined to include one or more steps or actions to be taken in response to one or more events and/or according to a schedule. Events may include receiving a healthcare message associated with one or more aspects of a clinical record, opening a record(s) for new patient(s), receiving a transferred patient, and/or any other instance and/or situation that requires or dictates responsive action or processing. The actions or steps of a clinical workflow may include placing an order for one or more clinical tests, scheduling a procedure, requesting certain information to supplement a received healthcare record, retrieving additional information associated with a patient, providing instructions to a patient and/or a healthcare practitioner associated with the treatment of the patient, and/or any other action useful in processing healthcare information. The defined clinical workflows can include manual actions or steps to be taken by, for example, an administrator or practitioner, electronic actions or steps to be taken by a system or device, and/or a combination of manual and electronic action(s) or step(s). While one entity of a healthcare enterprise may define a clinical workflow for a certain event in a first manner, a second entity of the healthcare enterprise may define a clinical workflow of that event in a second, different manner. In other words, different healthcare entities may treat or respond to the same event or circumstance in different fashions. Differences in workflow approaches may arise from varying preferences, capabilities, requirements or obligations, standards, protocols, etc. among the different healthcare entities.

However, the entities of a healthcare enterprise and/or entities from separate healthcare enterprises sometimes operate within a broader, interdependent information system, which hinder the ability of entities to customize clinical workflows. For example, the information system to which a healthcare entity belongs may place restrictions on changes to workflow applications or programs. Moreover, because some healthcare entities operate using systems, programs, devices, etc. from varying manufactures, software providers, etc., a lack of interoperability between the systems, programs, devices, etc. of each healthcare entity prohibits many customizations from realization. As a consequence of these example factors as well as additional or alternative factors, healthcare entities that desire customized clinical workflows are typically required to request such customizations from the manufactures, software providers, etc. Furthermore, for such customizations to implemented or integrated into a healthcare information system, a wide range of system-interrupting updates or re-releases occur within the information systems.

Generally, the example methods, apparatus, systems, and/or articles of manufacture disclosed herein enable healthcare entities of an enterprise clinical information system (ECIS) to dynamically customize one or more clinical workflows. Among other functions and/or benefits, the ECIS supports healthcare practitioners in decision making processes by aggregating healthcare information across disparate enterprises and/or entities thereof and referencing collection(s) of data (e.g., guidelines, recommendations related treatment and/or diagnosis, studies, histories, etc.) to automatically generate supportive information to be communicated to one or more healthcare practitioners related to the aggregated healthcare information. While each entity operates in connection with the ECIS that is administered by a provider thereof, the examples disclosed herein enable each entity of operating in connection with the ECIS to originate and/or modify one or more clinical workflows without relying on the provider of the ECIS to do so on behalf of the entity. In other words, although a healthcare entity is part of the ECIS and exchanges data with and via the ECIS, that entity can independently create and/or manage its clinical workflows using the examples disclosed herein. Furthermore, the examples disclosed herein enable entities of the ECIS to deploy or initiate the customized workflows without having to reboot or significantly interrupt the ECIS and/or the other components, workflows, etc. thereof. The example methods, apparatus, systems, and/or articles of manufacture disclosed herein and the advantages and/or benefits thereof are described in greater detail below in connection with the figures.

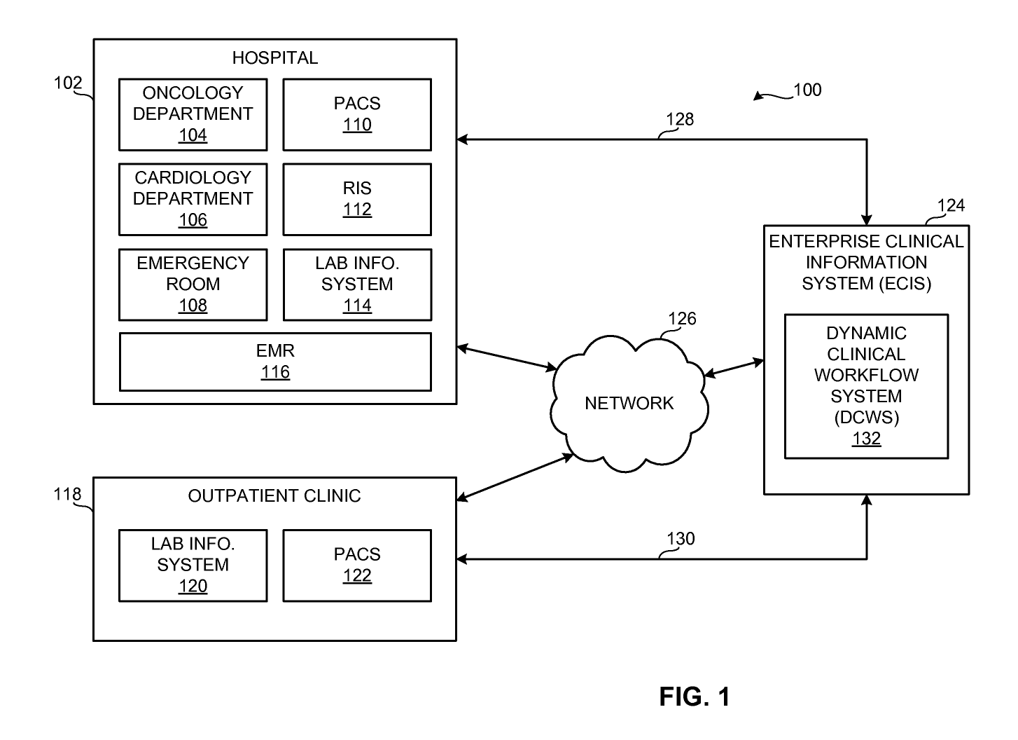

FIG. 1 is a block diagram of an example healthcare environment 100 in which the example methods, apparatus, systems, and/or articles of manufacture disclosed herein for dynamic customization of clinical workflows may be implemented. The example healthcare environment 100 of FIG. 1 includes a first hospital 102 having a plurality of entities operating within and/or in association with the first hospital 102. In the illustrated example, the entities of the first hospital 102 include an oncology department 104, a cardiology department 106, an emergency room system 108, a picture archiving and communication system (PACS) 110, a radiology information system (RIS) 112, and a laboratory information system (LIS) 114. The oncology department 104 includes cancer-related healthcare practitioners, staff and the devices or systems that support oncology practices and treatments. Similarly, the cardiology department 106 includes cardiology-related healthcare practitioners, staff and the devices and/or systems that support cardiology practices and treatments. Notably, the example oncology department 104 of FIG. 1 has specifically designed clinical workflows to be executed in response to certain events and/or according to a schedule. At the same time, the example cardiology department 106 of FIG. 1 has specifically designed clinical workflows to be executed in response to certain events and/or according to a schedule that differ from the clinical workflows of the example oncology department 104 of FIG. 1. For example, the oncology department 104 may execute a first set actions in response to receiving a Healthcare Level 7 (HL7) admission-discharge-transfer (ADT) message, while the cardiology department 106 executes a second set of actions different from the first set of actions in response to receiving a HL7 ADT message. Such differences may also exist between the emergency room 108, the PACS 110, the RIS 112 and/or the accounting services 114.

Briefly, the emergency room system 108 manages information related to the emergency care of patients presenting at an emergency room of the hospital 102, such as admission information, observations from emergency examinations of patients, treatments provided in the emergency room setting, etc. The PACS 110 stores medical images (e.g., x-rays, scans, three-dimensional renderings, etc.) as, for example, digital images in a database or registry. Images are stored in the PACS 110 by healthcare practitioners (e.g., imaging technicians, physicians, radiologists) after a medical imaging of a patient and/or are automatically transmitted from medical imaging devices to the PACS 110 for storage. The RIS 112 stores data related to radiology practices such as, for example, radiology reports, messages, warnings, alerts, patient scheduling information, patient demographic data, patient tracking information, and/or physician and patient status monitors, as well as enables exam order entry (e.g., ordering an x-ray of a patient) and image and film tracking (e.g., tracking identities of one or more people that have checked out a film). The lab information system 114 stores clinical information such as lab results, test scheduling information, corresponding practitioner(s), and/or other information related to the operation(s) of one or more labs at the corresponding healthcare facility. While example types of information are described above as being stored in certain elements of the hospital 102, different types of healthcare data may be stored in one or more of the entities 104-114, as the entities 104-114 and the information listed above is included herein as non-limiting examples. Further, the information stored in entities 104-114 may overlap and/or be combined into one or more of the entities 104-114. Each of the example entities 104-114 of FIG. 1 interacts with an electronic medical record (EMR) system 116. Generally, the EMR 116 stores electronic copies of healthcare records associated with, for example, the hospital 102 and the entities 104-114 thereof.

The example healthcare environment 100 of FIG. 1 also includes an outpatient clinic 118 as an example of another healthcare enterprise. The example outpatient clinic 118 of FIG. 1 includes a lab information system 120 and a PACS 122 that operate similarly to the corresponding entities of the example hospital 102. The lab information system 120 and the PACS 122 of the example outpatient clinic 118 operate according to specifically designed clinical workflows that differ between each other and the clinical workflows of the entities 104-114 of the hospital 102. Thus, differences in clinical workflows can exist between the entities of a healthcare enterprise and between healthcare enterprises in general.

In the illustrated example of FIG. 1, the hospital 102 and the outpatient clinic 118 are in communication with an ECIS 124 via a network 126, which may be implemented by, for example, a wireless or wired Wide Area Network (WAN) such as a private network or the Internet, an intranet, a virtual private network, a wired or wireless Local Area Network, etc. More generally, any of the coupling(s) described herein may be via a network. Additionally or alternatively, the example hospital 102 and/or the example outpatient clinic 118 are in communication with the example ECIS 124 via direct or dedicated transmission mediums 128 and 130.

Generally, the ECIS 124 supports healthcare information processing implemented by systems, devices, applications, etc. of healthcare enterprises, such as the hospital 102 and the outpatient clinic 118. The ECIS 124 is capable of processing healthcare messages from different entities of healthcare enterprises (e.g., the entities 104-114 of the hospital 102) that may generate, process and/or transmit the healthcare messages differently and/or using different formats, protocols, policies, terminology, etc. when generating, processing, and/or transmitting the healthcare messages. Moreover, the example ECIS 124 of FIG. 1 supports healthcare practitioners in decision making processes by aggregating healthcare information across disparate enterprises and/or entities thereof and referencing collection(s) of data to automatically generate suggestive and/or definitive data for communication to one or more healthcare practitioners related to the aggregated healthcare information.

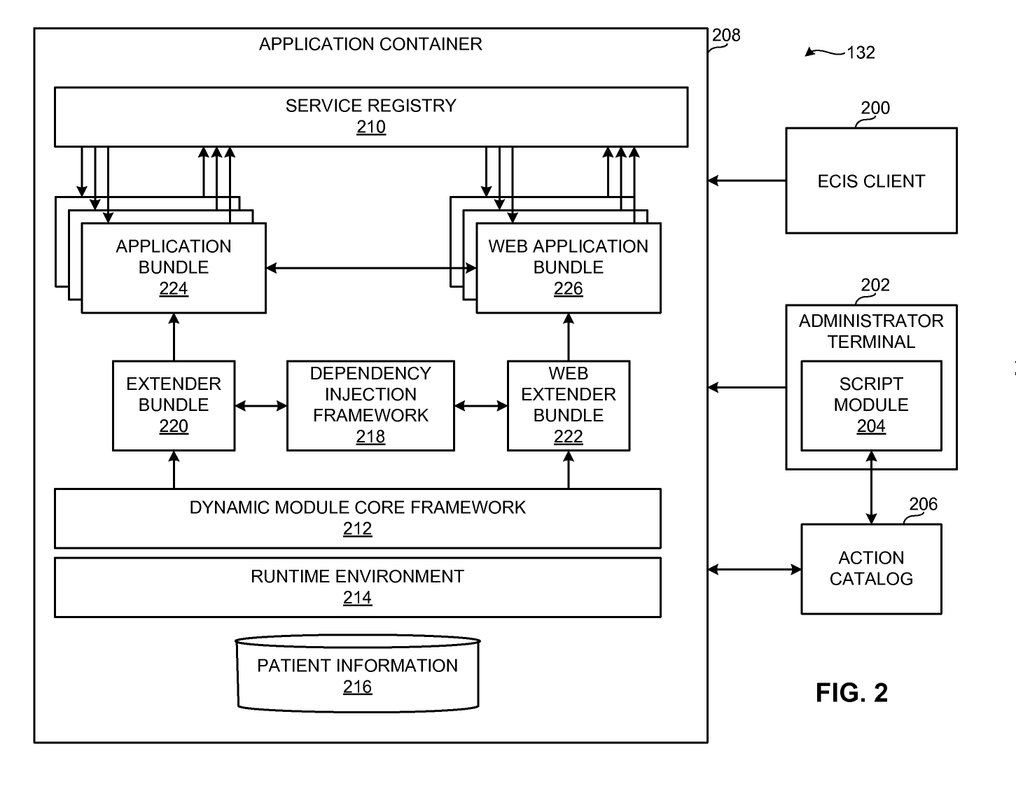

To enable the example ECIS 124 of FIG. 1 to provide the entities thereof the ability to dynamically customize clinical workflows, the example ECIS 124 includes a dynamic clinical workflow (DCW) system 132. Generally, the example DCW system 132 enables healthcare entities, such as the hospital 102 and the outpatient clinic 118 of FIG. 1, and the entities thereof, such as the oncology department 104 and the PACS 122 of FIG. 1, to create application(s) that define customized workflows and to transmit the customized workflows to the DCW system 132. In some examples, the DCW system 132 provides tools to the entities for the customization of the workflow applications. The tools may include, for example, a catalog of actions that may be executed in connection with specific types of healthcare data or messages. In addition, the example DCW system 132 enables the customizing entities to integrate the applications in a hot deployment, thereby avoiding the need to stop and restart supporting devices (e.g., servers). As a result, different entities across a healthcare enterprise implementing the example DCW system 132 disclosed herein can include multiple entities, each having a different (i.e., customized) version of a clinical workflow, wherein a first one of the entities can modify or update its version of the clinical workflow without having to interrupt operation of the other versions of the clinical workflows of the other entities. Additional or alternative aspects and advantages of the example DCW system 132 disclosed herein are described below in connection with FIGS. 2-5 below.

FIG. 2 is a block diagram of an example apparatus that may be used to implement the example DCW system 132 of FIG. 1. In the illustrated example of FIG. 2, the example DCW system 132 includes an ECIS client 200, an administrator terminal 202 having a script module 204, an action catalog 206, and an application container 208. The example application container 208 includes a service registry 210, a dynamic module core framework 212, a runtime environment 214, a patient data database 216, a dependency injection framework 218, an extender bundle 220, a web extender bundle 222, application bundles 224, and web application bundles 226. While an example manner of implementing the DCW system 132 of FIG. 1 has been illustrated in FIG. 2, one or more of the elements, processes and/or devices illustrated in FIG. 2 may be combined, divided, re-arranged, omitted, eliminated and/or implemented in any other way. Further, the example ECIS client 200, the example administrator terminal 202, the example script module 204, the example action catalog 206, the example application container 208, the example application container 208, the example service registry 210, the example dynamic module core framework 212, the example runtime environment 214, the example patient data database 216, the example dependency injection framework 218, the example extender bundle 220, the example web extender bundle 222, the example application bundles 224, the example web application bundles 226, and/or, more generally, the example DCW system 132 of FIG. 2 may be implemented by hardware, software, firmware and/or any combination of hardware, software and/or firmware. Thus, for example, any of the example ECIS client 200, the example administrator terminal 202, the example script module 204, the example action catalog 206, the example application container 208, the example application container 208, the example service registry 210, the example dynamic module core framework 212, the example runtime environment 214, the example patient data database 216, the example dependency injection framework 218, the example extender bundle 220, the example web extender bundle 222, the example application bundles 224, the example web application bundles 226, and/or, more generally, the example DCW system 132 of FIG. 2 can be implemented by one or more circuit(s), programmable processor(s), application specific integrated circuit(s) (ASIC(s)), programmable logic device(s) (PLD(s)) and/or field programmable logic device(s) (FPLD(s)), etc. When any of the appended claims are read to cover a purely software and/or firmware implementation, at least one of the example ECIS client 200, the example administrator terminal 202, the example script module 204, the example action catalog 206, the example application container 208, the example application container 208, the example service registry 210, the example dynamic module core framework 212, the example runtime environment 214, the example patient data database 216, the example dependency injection framework 218, the example extender bundle 220, the example web extender bundle 222, the example application bundles 224, the example web application bundles 226, and/or, more generally, the example DCW system 132 of FIG. 2 are hereby expressly defined to include a tangible medium such as a memory, DVD, CD, etc., storing the software and/or firmware. Further still, the example DCW system 132 of FIG. 2 may include one or more elements, processes and/or devices in addition to, or instead of, those illustrated in FIG. 2, and/or may include more than one of any or all of the illustrated elements, processes and devices.

As an illustration, the example ECIS client 200 of FIG. 2 is associated with and used by practitioners of the oncology department 104 of FIG. 1. However, the ECIS client 200 can be implemented in association with any of the entities 104-114 of the example hospital 102 or in association with any of the entities 120 and 122 of the outpatient clinic 118 of FIG. 1. The ECIS client 200 facilitates interactions between users (e.g., customers of an ECIS provider) of the ECIS 124 and the users thereof. For example, healthcare practitioners (e.g., surgeons, physicians, etc.) may use the example ECIS client 200 to access information stored in the patient information database 216 and/or to utilize one or more services provided by the ECIS 124 (e.g., an aggregation of patient data from disparate healthcare information systems and indications or suggestions related to treatment options based on the aggregation). The example ECIS client 200 can also be used in connection with one or more of the customized clinical workflows during execution of the clinical workflows (e.g., to determine a status of one or more actions of a clinical workflow, to fulfill one or more actions of the clinical workflow, etc.).

In the illustrated example, the administrator terminal 202 is also implemented in association with the oncology department 104 of FIG. 1. However, the administrator terminal 202 can be implemented in association with any of the entities 104-114 of the example hospital 102 or in association with any of the entities 120 and 122 of the outpatient clinic 118 of FIG. 1. The example administrator terminal 202 of FIG. 2 is used by, for example, a person (e.g., a technician or engineer) tasked with generating and/or modifying clinical workflows of the example DCW system 132 according to, for example, the instructions and/or preferences of healthcare practitioners associated with the oncology department 104 of FIG. 1 and/or any other entity of the healthcare environment 100 of FIG. 1. That is, healthcare practitioners that define a clinical workflow for a certain entity in response to a certain event and/or according to a schedule provide the customized clinical workflow to the field engineers who utilize the administrator terminal 202 to implement the defined clinical workflows. Thus, healthcare practitioners associated with the oncology department 104 may desire a first set of actions defining a first clinical workflow to be executed in response to receiving an ADT message. In such instances, a user of the administrator terminal 202 customizes an application for responding to ADT messages in accordance with the workflow defined by the practitioners associated with the oncology department 104. Similarly, healthcare practitioners associated with the cardiology department 106 may desire a second set of actions, different from the first set of actions in content and/or order of execution, defining a second clinical workflow to be executed in response to receiving an ADT message. In such instances, a user of an administrator terminal corresponding to the cardiology department 106 (which may be the terminal 202 of FIG. 2 or another terminal associated with the cardiology department 106) customizes an application for responding to ADT messages in accordance with the workflow defined by the practitioners associated with the cardiology department 106. As a result, two different entities 104 and 106 of the hospital 102 each have a version of an application that executes in response to ADT messages.

To enable users of the administrator terminal 202 to generate applications programmed in accordance with the desired workflow(s) of the healthcare practitioners of the corresponding healthcare entity, the example administrator terminal 202 of FIG. 2 includes the script module 204. In the illustrated example, the script module 204 implements an interface dedicated to the generation of Groovy® scripts, Groovy® being a dynamic programming language for the Java Virtual Machine®. However, the script module 204 may be implemented using any suitable programming language and/or scripting configuration.

The example script module 204 is in communication with the example action catalog 206. The example action catalog 206 includes a plurality of actions that can be utilized by a user of the script module 204 in the generation and/or customization of the example workflows described herein. From the example action catalog 206, the user of the script module 204 may select one or more actions and the order in which the selected action(s) are executed in response to a certain event and/or according to a schedule. Entries of the example action catalog 206 can be used alone or in combination with actions originated by the user of the script module 204 and/or the entity for which the user is operating. That is, action(s) selected from the example action catalog 206 of FIG. 2 can be inserted into existing clinical workflow(s) and/or clinical workflows being developed.

In the illustrated example, the actions of the action catalog 206 are segments of code (e.g., code of the same language as that used by the script module 204) designed to execute procedures related to the processing of healthcare information. For example, the actions represented by the code of the action catalog 206 may involve automatic placements of certain labs or tests in response to receiving a certain diagnosis in a healthcare message, generation of a new entry in a database in response to receiving a transfer patient via an ADT message, automatic communication with an insurer in response to receiving or in connection with creating an invoice, and/or any other action or procedure taken as part of healthcare information systems. In the example action catalog 206 of FIG. 2, the actions are categorized and the categorization of the actions is reflected in a graphical interface associated with the action catalog 206 implemented in association with the script module 204. Example categorizations include patient actions, location actions, encounter actions, contact actions, provider actions, observation actions, utility actions, etc. The example script module 204 of FIG. 2 interacts with the example action catalog 206 of FIG. 2 to enable, via an interface, users thereof to be presented with the categories and options for selecting a category such that the content of the selected category is presented to the user. Selection of one of the actions presents a summary of the action, typical uses for the action, source code for the action, and/or any other suitable information useful to users of the script module 204. Moreover, the selected action(s) can be downloaded or otherwise loaded onto the administrator terminal 202, after which the code of the selected action(s) can be modified and/or otherwise customized. The contents of the example action catalog 206 of FIG. 2 can be updated when, for example, a healthcare entity develops an action(s) that may be useful to other healthcare entities. That is, the example action catalog 206 can store new and/or updated versions of customized actions.

Thus, using the example script module 206 of FIG. 2, a user of the example administrator terminal 204 can generate one or more scripts to define the actions and/or series of actions to define a clinical workflow. The example administrator terminal 204 can also generate labeling information, such as an identifier or metadata, for the actions and/or series of actions created via the script module 206.

Generally, the example application container 208, which acts as a parent program capable of executing a set of related applications or programs, and the components thereof receive bundles from the administrator terminal 202 that include, among other types of information, the scripts generated via the script module 206 to implement the customized workflows of a corresponding healthcare entity. In addition to the customized script(s), the received bundles may include, for example, dependency information associated with each script of the bundle, metadata associated with the bundles, and/or other information related to the incoming data.

When such a bundle is received at the example application container 208 of FIG. 2, the bundle is loaded into the example dynamic module core framework 212. The example dynamic module core framework 212 of FIG. 2 is a module system and service platform that implements a dynamic component model in which bundles and/or applications of the bundles can be installed, started, stopped, updated, and uninstalled dynamically at runtime without requiring a reboot (e.g., of the application container 208). In the illustrated example of FIG. 2, the dynamic module core framework 212 is an OSGi framework, which is a dynamic module system for Java®. OSGi is a standard maintained by the OSGi Alliance, which is an open standards organization. Additionally, in the illustrated example, the runtime environment 214 is a Java runtime environment that utilizes the OSGi framework 212. However, the examples disclosed herein are not limited to the OSGi standard or the Java® runtime environment. Instead, the examples disclosed herein can be implemented in any suitable dynamic module framework that enables dynamic installation, initiation, uninstallation, etc. of clinical workflow bundles at runtime. The OSGi framework 212 enables different clinical workflows to be represented and implemented as modules that can have different life cycles and dependencies and still operate in the same system (e.g., the example ECIS 124 of FIG. 1).

The example OSGi framework 212 of FIG. 2 includes a file system into which the received bundle(s) are loaded. To integrate the scripts of the bundle(s) into the OSGi framework 212, the example container 208 includes the dependency injection framework 218 that communicates with the file system of the OSGi framework 212. In the illustrated example of FIG. 2, the example dependency injection framework 218 is implemented by a Spring DM (Dynamic Module) framework. Generally, the Spring DM framework 218 enables transparent exporting and importing of OSGi services, life cycle management and control. When a new application (e.g., clinical workflow) or a modification of an existing application occurs, the example Spring DM framework 218 facilitates a refresh of packages across the entire OSGi framework 212 or a given subset of installed bundles (e.g., according to dependencies of the bundles). The spring DM framework 218 utilizes the extender bundles 220 and 222 to publish the scripts of the bundles loaded into the file system of the OSGi framework 212 to the runtime environment 214. The example of FIG. 2 includes the two extender bundles 220 and 222 to handle different types of bundles. The web extender bundle 222 handles bundles involving web communication and/or utilization, while the extender bundle 220 handles bundles non involving web communication and/or utilization. In the OSGi framework 212, the unit of deployment and modularity corresponds to the bundles loaded into the file system. The bundles can be in an installed state, a resolved state, or an active state. In the Spring DM framework 218, the primary unit of modularity is an application context. The extender bundles 220 and 222 of FIG. 2 instantiate Spring DM application contexts for the bundles of the OSGi framework 212. More specifically, the extender bundles 220 and 222 detect bundles that are in the active state and, in response, create application contexts on behalf of the active bundles. The created application contexts are then instances of the corresponding workflows generated by the administrator terminal 202 as described above.

The bundles corresponding to the customized clinical workflows are shown in the illustrated example of FIG. 2 as the application bundles 224 and the web application bundles 226. Similar to the extender bundles 220 and 222, the two different types of application bundles are separated in FIG. 2 to reflect the handling of web applications and non-web applications by different types of bundles. In some examples, this distinction is not made and different types of applications can be handled collectively by a single grouping. The application bundles 224 and the web application bundles are registered with the service registry 210 which, in the illustrated example of FIG. 2 is implemented by an OSGi service registry. As a result of this registration, the clinical workflows of the application bundles 224 and/or 226 can be called upon and the OSGi service registry 210 can facilitate the execution of the clinical workflows by providing the clinical workflows the system resources demanded by the clinical workflows. Additionally, the example service registry 210 of FIG. 2 manages dependencies of the application bundles and makes the bundles available to other bundles registered with the service registry 210. In the illustrated example, aspects of the application bundles and/or the application bundles as a whole can be conveyed to the example action catalog 206 to augment the available actions for customization of the clinical workflows generated via the administrator terminal 202.

Therefore, the components of the example container 208 of FIG. 2 enable customized (e.g., via the script module 204 and the action catalog 206) clinical workflows to be registered (e.g., via the combination of the OSGi framework 212 and the Spring DM framework 218) with the ECIS 124 and deployed within the ECIS 124 dynamically and without having to reboot the system (e.g., via the combination of the OSGi framework 212 and the Spring DM framework 218). As a result, healthcare practitioners associated with the healthcare entities 102 and 118 of FIG. 1, for example, can create, modify, update clinical workflows that tailor to the needs of their own specific healthcare entity without having to request the customizations from a provider of the ECIS 124 and/or any other information system provider and without having to bring the entire ECIS 124 to a halt for the installation of the new or modified workflow applications.

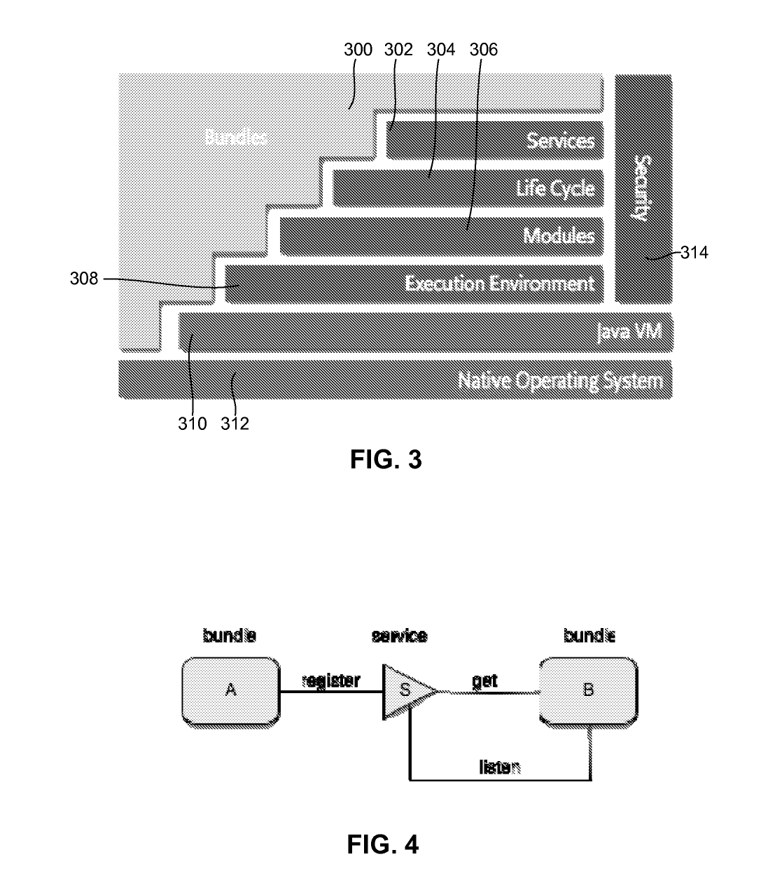

FIG. 3 is an illustration of the layered model of the OSGi framework 212 of FIG. 2. The model includes a bundles layer 300, a services layer 302, a life cycle layer 304, a modules layer 306, an execution environment layer 308, a Java virtual machine layer 310, a native operating system layer 312, and a security layer 314. These layers are described briefly herein and the specifications of the OSGi framework are incorporated herein by reference. The bundles layer 300 includes bundles created and/or modified by developers utilizing the OSGi framework 212. With reference to FIG. 2, the bundles layer 300 corresponds to the bundles generated using the script module 204 and the action catalog 206 by those tasked with creating code for the clinical workflows defined by the healthcare practitioners of one of the healthcare entities 104-114, 120 or 122 of FIG. 1. With reference to FIG. 2, the services layer 302 corresponds to the service registry 210. The bundles of the bundles layer 300 are registered with the service registry 302. As described above, the dependency injection framework or Spring DM framework 218 of FIG. 2 and the extender bundles 220 and 222 instantiate application contexts corresponding to the bundles for registration with the service registry 210 of the services layer 302. Moreover, the clinical workflows embodied in the bundles can be registered in the services layer 302, can get or retrieve a service registered with the services layer 302, and can listen for a service to appear or disappear. This is reflected in FIG. 4, which is a diagram illustrating interactions of the application bundles 224 and 226 of the bundles layer 300 with the service registry 210 of the services layer 302. The life cycle layer 304 represents an application interface capable of installing, starting, stopping, updating, and uninstalling bundles. The modules layer 306 defines how the bundles can import and export code. Briefly, the modularity facilitated by the modules layer 306 maintains the bundles as local components unless a bundle is explicitly exported. That is, a bundle that wants to use another must import the components thereof. The execution environment layer 308 defines what methods and classes are available in a specific platform. The Java virtual machine layer 310 and the native operating system layer 312 interact to execute the runtime environment 214 and the code being processed thereby. The security layer 314 handles security issues and/or policies associated with the OSGi framework 212.

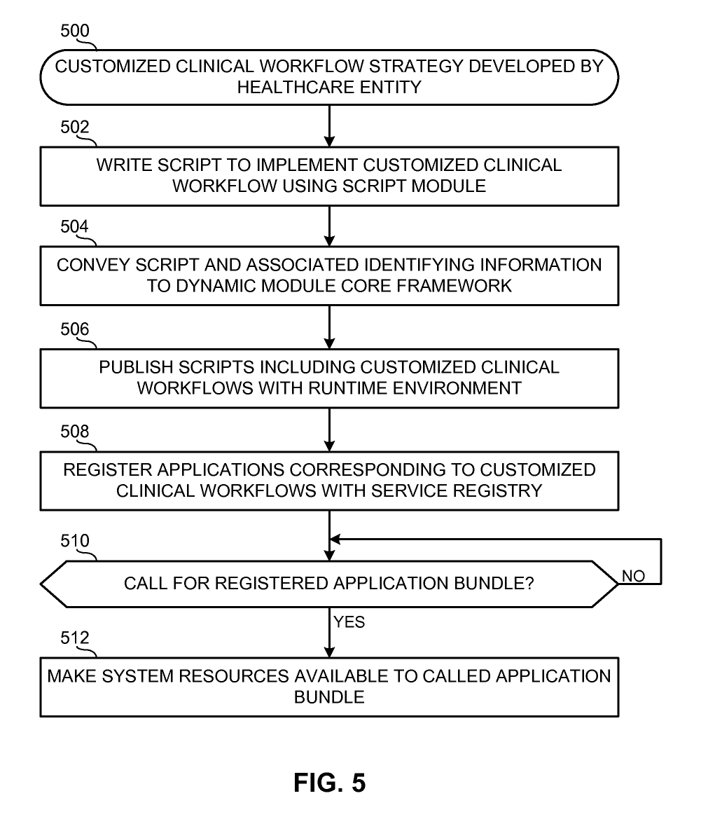

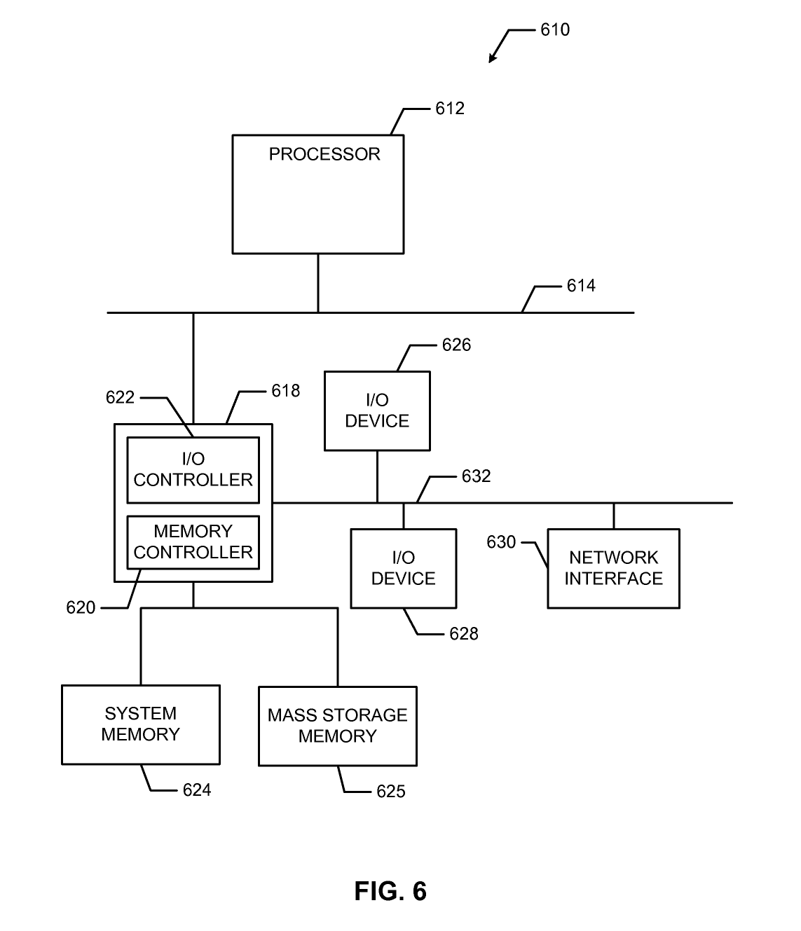

The flow diagram depicted in FIG. 5 is representative of machine readable instructions that can be executed to implement the example DCW system 132 of FIGS. 1 and/or 2 for dynamic customization of clinical workflows. The example processes of FIG. 5 may be performed using a processor, a controller and/or any other suitable processing device. For example, the example processes of FIG. 5 may be implemented in coded instructions stored on a tangible medium such as a flash memory, a read-only memory (ROM) and/or random-access memory (RAM) associated with a processor (e.g., the example processor 612 discussed below in connection with FIG. 6). Alternatively, some or all of the example processes of FIG. 5 may be implemented using any combination(s) of application specific integrated circuit(s) (ASIC(s)), programmable logic device(s) (PLD(s)), field programmable logic device(s) (FPLD(s)), discrete logic, hardware, firmware, etc. Also, some or all of the example processes of FIG. 5 may be implemented manually or as any combination(s) of any of the foregoing techniques, for example, any combination of firmware, software, discrete logic and/or hardware. Further, although the example processes of FIG. 5 are described with reference to the flow diagrams of FIG. 5, other methods of implementing the processes of FIG. 5 may be employed. For example, the order of execution of the blocks may be changed, and/or some of the blocks described may be changed, eliminated, sub-divided, or combined. Additionally, any or all of the example processes of FIG. 5 may be performed sequentially and/or in parallel by, for example, separate processing threads, processors, devices, discrete logic, circuits, etc.

Turning to FIG. 5, a practitioner associated with one of the entities 104-114, 120 and 122 of FIG. 1 may develop customized clinical workflows to define actions to be taken, for example, in response to an event and/or according to a schedule. The illustrated example of FIG. 5 begins with the development of such a customized clinical workflow (block 500). To implement the clinical workflow, a person associated with the developing healthcare entity uses the script module 204 of FIG. 2 to generate a script that follows the customized clinical workflow (block 502). As described above, the example action catalog 206 can be utilized in conjunction with the script module 204 to utilize previously generated actions that can be combined (e.g., with each other or original segments of code) to embody a clinical workflow. The generated script is then conveyed to the dynamic module core framework 212 of FIG. 2 for integrations into the ECIS 124 of FIG. 1 as bundles to be loaded into a file system of the example dynamic module core framework 212 (block 504).

The example dependency injection framework 218 then uses the example extender bundles 220 and 222 to publish the scripts, which can be extracted from the bundles received at the example dynamic module core framework 212, to the runtime environment 214 (block 506). That is, the extender bundles 220 and 222 refresh the runtime environment 214 to include instances (e.g., application contexts in the Spring DM framework) of the applications corresponding to the received scripts. The application or script is then registered with the example service registry 210 of FIG. 2 (block 508). As described above, the example service registry 210, among other functions, allows the registered application bundles to be used by other applications, manages dependencies between the application bundles 224 and 226, etc. Moreover, the example service registry 210 and the example dynamic module core framework 212 enable the DCW system 134 to listen for calls to the application bundle registered with the service registry 210. When such a call is detected (block 510), the example service registry 210 makes the system resources called for by the requested application bundle available thereto (block 512).

FIG. 6 is a block diagram of an example processor system 610 that may be used to implement the apparatus and methods described herein. As shown in FIG. 6, the processor system 610 includes a processor 612 that is coupled to an interconnection bus 614. The processor 612 may be any suitable processor, processing unit or microprocessor. Although not shown in FIG. 6, the system 610 may be a multi-processor system and, thus, may include one or more additional processors that are identical or similar to the processor 612 and that are communicatively coupled to the interconnection bus 614.

The processor 612 of FIG. 6 is coupled to a chipset 618, which includes a memory controller 620 and an input/output (I/O) controller 622. As is well known, a chipset typically provides I/O and memory management functions as well as a plurality of general purpose and/or special purpose registers, timers, etc. that are accessible or used by one or more processors coupled to the chipset 618. The memory controller 620 performs functions that enable the processor 612 (or processors if there are multiple processors) to access a system memory 624 and a mass storage memory 625.

The system memory 624 may include any desired type of volatile and/or non-volatile memory such as, for example, static random access memory (SRAM), dynamic random access memory (DRAM), flash memory, read-only memory (ROM), etc. The mass storage memory 625 may include any desired type of mass storage device including hard disk drives, optical drives, tape storage devices, etc.

The I/O controller 622 performs functions that enable the processor 612 to communicate with peripheral input/output (I/O) devices 626 and 628 and a network interface 630 via an I/O bus 632. The I/O devices 626 and 628 may be any desired type of I/O device such as, for example, a keyboard, a video display or monitor, a mouse, etc. The network interface 630 may be, for example, an Ethernet device, an asynchronous transfer mode (ATM) device, an 802.11 device, a DSL modem, a cable modem, a cellular modem, etc. that enables the processor system 610 to communicate with another processor system.

While the memory controller 620 and the I/O controller 622 are depicted in FIG. 6 as separate blocks within the chipset 618, the functions performed by these blocks may be integrated within a single semiconductor circuit or may be implemented using two or more separate integrated circuits.

Thus, the example methods, apparatus, systems, and/or articles of manufacture disclosed herein enable an exchange of linkage information between healthcare entities such that healthcare practitioners associated with entities are quickly, efficiently, and accurately made aware of clinical items associated with medical issues of transferred patients. In addition to other benefits and advantages, the example methods, apparatus, systems, and/or articles of manufacture disclosed herein reduce or, in some instances, eliminate the need for the practitioners to reconcile clinical items with medical issues. As a result, the practitioners can provide more accurate and safe care in a more efficient manner. Additionally, the practitioners can focus a transfer process and the exchange of information associated therewith on the clinical items related to the medical issue(s) for which the patient is being transferred.

Certain embodiments contemplate methods, systems and computer program products on any machine-readable media to implement functionality described above. Certain embodiments may be implemented using an existing computer processor, or by a special purpose computer processor incorporated for this or another purpose or by a hardwired and/or firmware system, for example.

Certain embodiments include computer-readable media for carrying or having computer-executable instructions or data structures stored thereon. Such computer-readable media may be any available media that may be accessed by a general purpose or special purpose computer or other machine with a processor. By way of example, such computer-readable media may comprise RAM, ROM, PROM, EPROM, EEPROM, Flash, CD-ROM or other optical disk storage, magnetic disk storage or other magnetic storage devices, or any other medium which can be used to carry or store desired program code in the form of computer-executable instructions or data structures and which can be accessed by a general purpose or special purpose computer or other machine with a processor. Combinations of the above are also included within the scope of computer-readable media. Computer-executable instructions comprise, for example, instructions and data which cause a general purpose computer, special purpose computer, or special purpose processing machines to perform a certain function or group of functions.

Generally, computer-executable instructions include routines, programs, objects, components, data structures, etc., that perform particular tasks or implement particular abstract data types. Computer-executable instructions, associated data structures, and program modules represent examples of program code for executing steps of certain methods and systems disclosed herein. The particular sequence of such executable instructions or associated data structures represent examples of corresponding acts for implementing the functions described in such steps.

Embodiments of the present invention may be practiced in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet and may use a wide variety of different communication protocols. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. Embodiments of the invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

Although certain methods, apparatus, and articles of manufacture have been described herein, the scope of coverage of this patent is not limited thereto. To the contrary, this patent covers all methods, apparatus, and articles of manufacture fairly falling within the scope of the appended claims either literally or under the doctrine of equivalents.

What is claimed is:

1. A computer implemented method, comprising:
receiving a script that implements one or more actions of a clinical workflow from a first healthcare entity that utilizes an electronic clinical information system, wherein the electronic clinical information system aggregates healthcare information from a plurality of healthcare entities including the first healthcare entity;
loading the script into a dynamic module core framework that interacts with a runtime environment to execute application bundles; and
publishing the script of the dynamic module core framework to the runtime environment such that the clinical workflow is installed into the electronic clinical information system dynamically at runtime.

2. A computer implemented method as defined in claim 1, wherein the script is to be included in one of the application bundles to be executed via the runtime environment.

3. A computer implemented method as defined in claim 1, further comprising registering the script with a service registry associated with the dynamic module core network.

4. A computer implemented method as defined in claim 2, wherein the service registry is to make the script of the first healthcare entity available to a second healthcare entity that utilizes the electronic clinical information system.

5. A computer implemented method as defined in claim 1, further comprising conveying the script to an action catalog from which actions can be selected and used in scripts that implement clinical workflows in association with the electronic clinical information system.

6. A computer implemented method as defined in claim 1, wherein publishing the script to the runtime environment is implemented by a dependency injection framework.

7. A computer implemented method as defined in claim 6, wherein the dependency injection framework utilizes one or more extender bundles to publish the script to the runtime environment dynamically at runtime.

8. A tangible computer readable medium having instructions stored thereon that, when executed, cause a machine to at least:
receive a script that implements one or more actions of a clinical workflow from a first healthcare entity that utilizes an electronic clinical information system, wherein the electronic clinical information system aggregates healthcare information from a plurality of healthcare entities including the first healthcare entity;
load the script into a dynamic module core framework that interacts with a runtime environment to execute application bundles; and
publish the script of the dynamic module core framework to the runtime environment such that the clinical workflow is installed into the electronic clinical information system dynamically at runtime.

9. A tangible computer readable medium as defined in claim 8, wherein the script is to be included in one of the application bundles to be executed via the runtime environment.

10. A tangible computer readable medium as defined in claim 8, wherein the instructions, when executed, cause a machine to register the script with a service registry associated with the dynamic module core network.

11. A tangible computer readable medium as defined in claim 10, wherein the service registry is to make the script of the first healthcare entity available to a second healthcare entity that utilizes the electronic clinical information system.

12. A tangible computer readable medium as defined in claim 8, wherein the instructions, when executed, cause a machine to convey the script to an action catalog from which actions can be selected and used in scripts that implement clinical workflows in association with the electronic clinical information system.

13. A tangible computer readable medium as defined in claim 8, wherein publishing the script to the runtime environment is implemented by a dependency injection framework.

14. A tangible computer readable medium as defined in claim 13, wherein the dependency injection framework utilizes one or more extender bundles to publish the script to the runtime environment dynamically at runtime.

15. An apparatus, comprising:
an application container to receive a script that implements one or more actions of a clinical workflow from a first healthcare entity that utilizes an electronic clinical information system, wherein the electronic clinical information system aggregates healthcare information from a plurality of healthcare entities including the first healthcare entity;
a dynamic module core framework into which the script is to be loaded that interacts with a runtime environment to execute application bundles; and
a dependency injection framework to publish the script of the dynamic module core framework to the runtime environment such that the clinical workflow is installed into the electronic clinical information system dynamically at runtime.

16. An apparatus as defined in claim 15, wherein the script is to be included in one of the application bundles to be executed via the runtime environment.

17. An apparatus as defined in claim 15, further comprising a service registry associated with the dynamic module core framework with the script is to be registered.

18. An apparatus as defined in claim 17, wherein the service registry is to make the script of the first healthcare entity available to a second healthcare entity that utilizes the electronic clinical information system.

19. An apparatus as defined in claim 15, further comprising an action catalog from which actions can be selected and used in scripts that implement clinical workflows in association with the electronic clinical information system.

20. An apparatus as defined in claim 15, wherein the dependency injection framework utilizes one or more extender bundles to publish the script to the runtime environment dynamically at runtime.
